(19) United States
(12) Patent Application Publication
(10) Pub. No.: US 2008/0289654 A1
(43) Pub. Date: Nov. 27, 2008

(54) Dish washing machine and control method of the same

(75) Inventors: Seong Ho Kim, Seoul (KR); Tae Hee Lee, Seoul (KR)

Correspondence Address: MCKENNA LONG & ALDRIDGE LLP, 1900 K STREET, NW, WASHINGTON, DC, 20006, US

(73) Assignee: LG. Electronics, Inc., Seoul (KR)

(21) Appl. No.: 11/882,092

(22) Filed: Jul. 30, 2007

(30) Foreign Application Priority Data
Mar. 31, 2007 (KR) 10-2007-0032120

(51) Int. Cl. A47L 15/46; B08B 3/04; B08B 7/04

(52) U.S. Cl. 134/18; 134/56 D; 134/25.2

(57) ABSTRACT

A dish washing machine and a control method of the same are disclosed. The dish washing machine may include a first heater for heating wash water to wash items in a dishwasher. The dishwasher may also include a second heater for generating steam to be supplied to the dishes. A controller is configured to control the first and second heaters to operate alternately.

This application claims the benefit of Korean Patent Application No. 10-2007-0032120, filed on Mar. 31, 2007, which is hereby incorporated by reference as if fully set forth herein.

### BACKGROUND

1. Field of the Invention

The present invention relates to a home appliance, and more particularly to a dish washing machine and a control method of the same which are configured to enhance the washing performance of the dish washing machine, efficiently.

2. Discussion of the Related Art

Generally, dish washing machines are known as an apparatus for automatically washing items, such as dishes disposed in a washing compartment by spraying wash water toward the dishes under high pressure, and thus, removing foreign matter such as food residues attached to the surfaces of the dishes.

An important factor associated with such a dish washing machine relates to washability and cleanly removing food residues attached to the surfaces of dishes. In order to achieve an enhancement in washability, it is often necessary to increase the force required to remove foreign matter from the surfaces of dishes, namely, the spray pressure of wash water.

However, when the spray pressure of the wash water is excessively high, the dishes may be damaged or easily broken. Furthermore, an increased spray pressure for washing dishes typically correlates to an increase in the amount of wash water required.

In addition, when wash water of an increased spray pressure is used, it is often necessary to increase the power consumption of a pump used to supply the wash water.

### SUMMARY

This disclosure relates to a dish washing machine and a control method of the same that substantially obviate one or more problems due to limitations and disadvantages of the related art.

A dish washing machine and a control method of the same are configured to safely and efficiently clean dishes.

A dish washing machine and a control method of the same are configured to achieve a reduction in the amount of wash water used, while increasing wash performance.

Advantages and features will be set forth in part in the description which follows and in part will become apparent to those having ordinary skill in the art upon examination of the following or may be learned from practice of the invention. The aforementioned advantages and features may be realized and attained by the exemplary structure and/or method pointed out in the written description, claims, and appended drawings.

The advantages may be achieved by a dish washing machine that may comprise: a first heater to heat wash water for washing; a second heater to generate steam to be supplied to the dish washing machine; and a controller to control the first and second heaters to operate alternately.

The advantages may also be achieved by a dish washing machine comprising: a first heater for heating wash water for washing; a second heater for generating steam to be supplied to the dish washing machine; and a washing compartment to provide an interior space for washing to which the steam and the water are supplied, wherein a temperature increment by the first heater is followed by a temperature increment by the second heater in the washing compartment in an alternating sequence.

It is to be understood that both the foregoing general description and the following detailed description shall not be construed as limiting the scope of the claims.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view schematically illustrating a dish washing machine according to an embodiment of the present invention;

FIG. 2 is a diagram schematically depicting operations of the dish washing machine shown in FIG. 1;

FIG. 3 is a diagram depicting an embodiment of operations executed in a main washing cycle shown in FIG. 2; and

FIG. 4 is a diagram depicting another embodiment of operations executed in a main washing cycle shown in FIG. 2.

### DETAILED DESCRIPTION

Reference will now be made in detail to the preferred embodiments of the present invention, examples of which are illustrated in the accompanying drawings. Wherever possible, the same reference numbers will be used throughout the drawings to refer to the same or like parts.

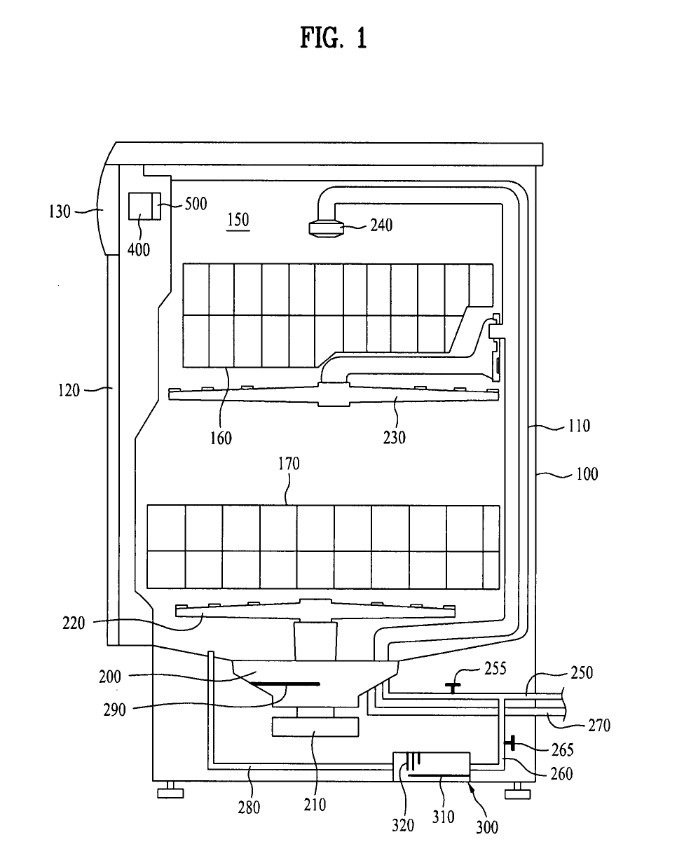

The configuration of a dish washing machine according to an exemplary embodiment of the present invention will be described with reference to FIG. 1.

The illustrated dish washing machine may include a case 100 defining the appearance or exterior of the dish washing machine, a door 120 for opening or closing the case 100, and a control panel 130 mounted to the case 100 or door 120, to enable the user to control or manipulate the dish washing machine.

A tub 110 is arranged in the case 100, to define a washing compartment 150 in the case 100, as a space in which dishes are received and washed. A sump 200 for storing wash water is arranged beneath the tub 110.

Arranged together with the sump 200 is a pump 210 for pumping the wash water stored in the sump 200 and a filter (not shown) for filtering contaminated wash water. A first heater 290 may be arranged in the sump 200 or functionally arranged to operate with the sump 200, to heat the wash water stored in the sump 200.

A first water supply tube 250 is connected to the sump 200, to supply fresh water from an external water supply source to the sump 200. A water discharge tube 270 is connected to the sump 200, to externally discharge the wash water from the sump 200. A first water supply valve 255 for controlling the supply of water to the sump 200 is arranged in the water supply tube 250.

At least one rack is arranged in the interior of the tub 110, namely, the washing compartment 150. At least one spray arm is arranged in the washing compartment 150, to spray or distribute the water pumped by the pump 210 toward at least one rack.

As an example, FIG. 1 illustrates a dish washing machine in which an upper rack 160 and a lower rack 170 are arranged at upper and lower portions of the washing compartment 150, respectively, and an upper spray arm 230 and a lower spray arm 220 are arranged such that they are configured to spray water pumped by the pump 210 toward the upper rack 160 and lower rack 170, respectively.

In addition, a top nozzle 240 may be arranged at or near a top portion of the washing compartment 150. The top nozzle 240 functions to downwardly spray water pumped by the pump 210 from the top portion of the washing compartment 150.

The dish washing machine according to the illustrated embodiment is configured to spray wash water into the washing compartment 150 by the pump 210 and spray arms 220 and 230. The dish washing machine is configured to spray or supply steam to the washing compartment 150. To this end, the dish washing machine includes a steam generator 300, which operates independently of the first heater 290 arranged in the sump 200.

As shown in FIG. 1, the steam generator 300 is configured to communicate with the first water supply tube 250 via a second water supply tube 260. The steam generator 300 is configured to communicate with the washing compartment 150 of the tub 110 via a steam supply tube 280. A second water supply valve 265 for controlling the supply of water to the steam generator 300 is arranged along the second water supply tube 260.

The steam generator 300 includes a second heater 310 for heating water supplied to the steam generator 300 to generate steam, and a water level sensor 320 for sensing the water level of the steam generator 300. The water level sensor 320 may sense, for example, a minimum water level and a maximum water level.

The water level sensor 230 may be set to detect a minimum water level to protect the second heater 310 of the steam generator 300. Additionally or alternatively, the water level sensor 230 may be set to detect a maximum water level to prevent the water supplied to the steam generator 300 from overflowing the steam generator 300.

A controller 400, executing instructions in a memory 500, as well known in the art, is configured to control the dish washing machine. The controller 400 is electrically connected to electrically-operating elements, for example, the control panel 130, the pump 210, and the steam generator 300, to control the operation of the dish washing machine.

In detail, the controller 400 is configured to receive instructions such that the controller is enabled to alternately operate the first heater 290 and the second heater 310. The controller 400 is configured to perform a control operation to alternately supply steam and water to the washing compartment 150.

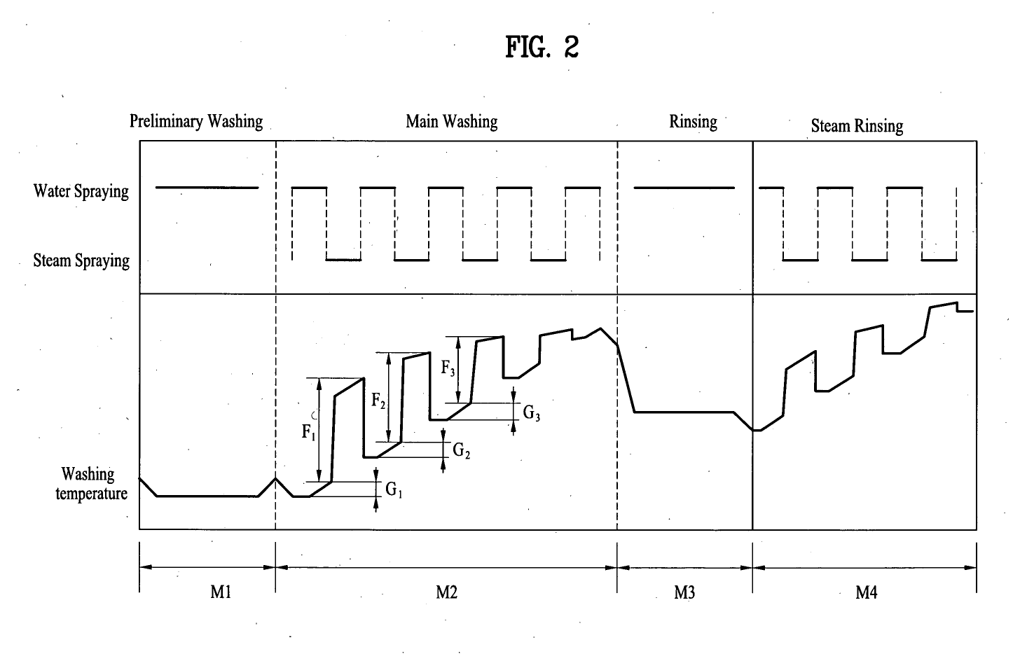

Hereinafter, a procedure for washing dishes will be described in detail with reference to FIG. 2.

The cycle performed in the dish washing machine according to the illustrated embodiment mainly includes a preliminary washing cycle M1, a main washing cycle M2, and a rinsing cycle M3. Additionally or alternatively, a steam rinsing cycle M4 may be included.

The preliminary washing cycle M1 is a procedure for washing dishes, preferably using wash water containing no detergent. The main washing cycle M2 is a procedure for washing dishes, usually using wash water containing a detergent. The rinsing cycle M3 is a procedure for rinsing dishes and spraying wash water onto the dishes washed in the main washing cycle M2. The steam rinsing procedure M4 is a procedure for rinsing dishes that includes a water spraying procedure and a steam spraying procedure.

In the preliminary washing cycle M1, water externally supplied to the sump is supplied to the dishes under the condition in which the water is maintained in a low-temperature state without necessarily requiring heat. The preliminary washing cycle M1 is adapted to roughly remove foreign matter, which may be attached to the dishes. Optionally, heated wash water may be supplied in the preliminary washing cycle. After completion of the preliminary washing cycle, the main washing cycle M2 is carried out. In the main washing cycle M2, a water spraying procedure, in which heated wash water is supplied, and a steam spraying procedure, in which steam is supplied, are configured to be alternately carried out.

For example, wash water heated by the first heater 290 is first supplied for a predetermined time, and steam generated by the second heater 310 is then supplied for a predetermined time. In the main washing cycle M2, the water spraying procedure and the steam spraying procedure are alternately performed and repeated for a predetermined number of times.

The water spraying procedure may include a function for removing foreign matter attached to dishes, whereas the steam spraying procedure may include a function for soaking foreign matter attached to dishes in water, to allow the foreign matter to be easily detached from the dishes.

In the above procedures, a continuous increase in washing temperature may occur for a period of time. This may occur because the internal temperature of the washing compartment and the surface temperature of the dishes increase continuously due to the influence of the heated wash water and steam.

In detail, a temperature increment “Gᵢ” represents a temperature increment of the washing compartment as a result of the i^{th} water spray procedure associated with the first heater 290. A temperature increment “Fᵢ” represents a temperature increment of the washing compartment as a result of the i^{th} steam spray procedure associated with the second heater 310. In this example, a temperature increment, Gᵢ, is followed by a temperature increment, Fᵢ, such that they alternate.

As illustrated in FIG. 2, G₁ refers to the temperature increment of the washing compartment as result of a first water spray procedure. G₂ refers to the temperature increment of the washing compartment as result of a second water spray procedure. G₃ refers to the temperature increment of the washing compartment as result of a third water spray procedure. Further, F₁ refers to the temperature increment of the washing compartment as a result of a first steam spray procedure. F₂ refers to the temperature increment of the washing compartment as result of a second steam spray procedure. F₃ refers to the temperature increment of the washing compartment as result of a third steam spray procedure.

In this example, a temperature increment of a steam spray procedure (e.g., Fᵢ . . . Fₙ) may be graphically represented by a step formation with respect to temperature and time. In this example, a temperature increment of a water spray procedures (e.g., Gᵢ . . . Gₙ) may be graphically represented by a positive sloping line.

The extent and/or magnitude of the temperature increments of the steam spray procedures (F₁, F₂, F₃) gradually diminish during the course of the main washing cycle.

It is to be understood that both the foregoing general description and the following detailed description are exemplary and explanatory.

Optionally, each water spray procedure and/or each stream spray procedure may include an upper spray procedure carried out through the upper spray arm and/or a lower spray procedure carried out through the lower spray arm.

After completion of the main washing procedure, the rinsing cycle M3 may be carried out. In the rinsing cycle M3, the wash water circulated during the main washing procedure is externally discharged through the discharge tube 270, and fresh water is supplied and sprayed onto the dishes. In the rinsing cycle M3, only wash water without detergent is typically supplied and sprayed onto the dishes. In this case, the wash water may be supplied in a heated state or an unheated state.

Even when unheated wash water is supplied, the washing temperature in the rinsing cycle is almost always higher than the washing temperature in the preliminary washing cycle. This may occur because the temperature of the dishes and the internal temperature of the washing compartment may have already been increased to a certain high temperature in accordance with the execution of the main washing cycle.

A rinsing cycle and/or a steam rinsing cycle may be included. In a steam rinsing cycle, water and steam may be simultaneously sprayed, alternately sprayed, or some variation thereof. A drying cycle may also be carried out after completion of the rinsing cycle and/or the steam rinsing cycle. In the drying cycle, a wind or air stream of a predetermined temperature may be blown into the washing compartment to dry, for example, any items in the racks.

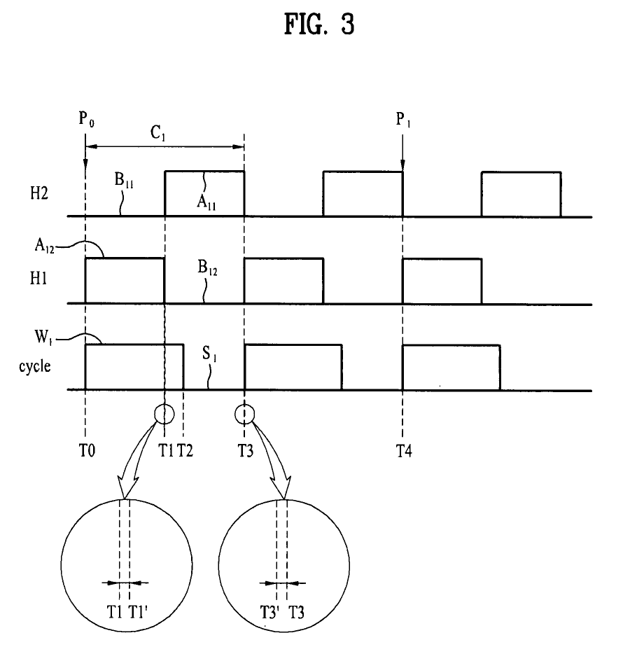

The main washing cycle carried out in the dish washing machine according to an illustrated embodiment will now be described in detail with reference to FIG. 3.

As described with reference to FIG. 2, the main washing cycle includes a water spraying procedure W₁ for spraying heated wash water in the washing compartment, and a steam spraying procedure S₁ for spraying steam in the washing compartment, alternately with the water spraying procedure.

In FIG. 3, the first heater is designated by “H1”, and the second heater is designated by “H2”. As an example, execution of one water spraying procedure and one steam spraying procedure is referred to as “one cycle C₁”.

The main washing cycle is divided into a plurality of cycles C₁. Water may be supplied to the steam generator after execution of every two cycles C₁. As shown in FIG. 3, at a point of time P1 when two cycles C₁ have elapsed after water was first supplied to the steam generator at a point of time P0, water is secondarily supplied to the steam generator.

Optionally, the point of time, in which water is supplied to the steam generator, may be set based on the temperature of the second heater, the operation time of the second heater, the amount of water contained in the steam generator, the capacity of the steam generator, the set water levels of the steam generator, and other factors.

When the main washing cycle starts, heated wash water is sprayed in the washing compartment, for example, onto any items on the racks. For this operation, the controller first drives the first heater. In FIG. 3, “A₁₂” represents an operation time for which the first heater operates. The operation time A₁₂ corresponds to a time “T1-T0”. Also, “B₁₂” represents a period in which the first heater does not operate. The period B₁₂ corresponds to a time “T3-T1”.

Here, “T0” represents the point of time when the main washing cycle starts, namely, the point of time when the first heater starts to operate. “T1” represents the point of time when the operation of the first heater stops. “T3” represents the point of time when the first heater starts to operate again.

Simultaneously with the operation of the first heater, the water spraying procedure W₁ starts to spray water onto the dishes. Accordingly, the point of time when the water spraying procedure W₁ starts corresponds to “T0”, and the point of time when the water spraying procedure W₁ is completed corresponds to “T2”.

As a result, even after the operation of the first heater stops, the water spraying procedure W₁ is continuously carried out for a time “T2-T1”. That is, the period of time, for which wash water is sprayed in the water spraying procedure W₁, is longer than the operation time of the first heater.

Meanwhile, when the operation of the first heater stops, the second heater starts to operate. In this case, the controller preferably controls the first and second heaters to operate alternately at intervals of a predetermined time Δα.

The time interval Δα represents the time difference between the point of time T1′ when the second heater starts to operate to the point of time T1 when the operation of the first heater stops. The reason why the above-described time difference is provided is that, when the first and second heaters are simultaneously controlled, the controller may be momentarily subjected to an overload.

In FIG. 3, “A₁₁” represents an operation time for which the second heater operates. The operation time A₁₁ corresponds to a time “T3′-T1′”. Also, “B₁₁” represents a period in which the second heater does not operate. The period B₁₁ corresponds to a time “T1′-T0”.

Here, “T0” represents the point of time when the main washing cycle starts. “T1′” represents the point of time when the second heater starts to operate. “T3′” represents the point of time when the operation of the second heater stops.

Meanwhile, after a predetermined time, namely, a time “T2-T1′” elapses, the steam spraying procedure S₁ starts. The point of time when the steam spraying procedure S₁ starts is T2, whereas the point of time when the steam spraying procedure S₁ is completed is T3. That is, the time taken to complete the steam spraying procedure corresponds to a time “T3-T2”.

As a result, in order to generate steam upon completion of the spraying of the wash water, the second heater heats the wash water for a time “T1′-T2”, for the generation of steam prior to the completion of the spraying of wash water. That is, the second heater operates before a substantial supply of steam starts. Thus, the supply of water and the supply of steam are successively carried out such that the steam spraying procedure occurs immediately after the water spraying procedure or such that the steam spraying procedure occurs at substantially the same time that the water spraying procedure is completed.

The period of time, for which the water spraying procedure for spraying wash water is carried out, is set to be different from the period of time for which the steam spraying procedure is carried out. In detail, the period of the water spraying procedure is set to be longer than the period of the steam spraying procedure. The period of the water spraying procedure is set to be longer than the operation period of the second heater by a time “T2-T1.” Here, the ratio between the period of the water spraying procedure and the period of the steam spraying procedure is about 5:3. Meanwhile, the operation time of the first heater and the operation time of the second heater are controlled to be substantially equal. That is, the periods A₁₁ and A₁₂ are substantially equal.

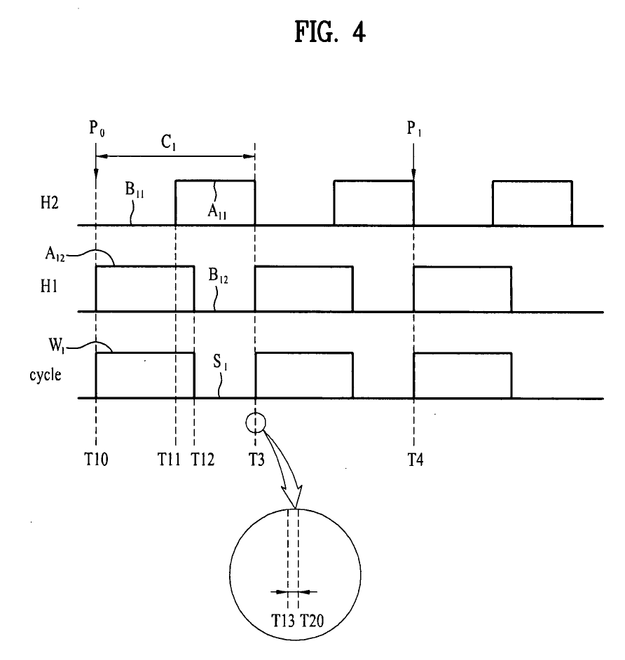

Hereinafter, operation of the dish washing machine according to another embodiment of the present invention will be described with reference to FIG. 4.

In accordance with this embodiment, the operation time of the first heater for heating wash water contained in the sump and the operation time of the second heater installed in the steam generator to generate steam have an overlap period.

When the main washing cycle starts, heated wash water is sprayed, for example, onto any items in the washing compartment. For this operation, the controller first drives the first heater. In FIG. 4, “A₁₂” represents an operation time for which the first heater or sump heater operates. The operation time A₁₂ corresponds to a time “T₁₂-T₁₀.” Also, “B₁₂” represents a period in which the first heater does not operate. The period B₁₂ corresponds to a time “T₂₀-T₁₂”.

Here, “T₁₀” represents the point of time when the main washing cycle starts, namely, the point of time when the first heater starts to operate. “T₁₂” represents the point of time when the operation of the first heater stops. “T₂₀” represents the point of time when the first heater starts to operate again.

Simultaneously with the operation of the first heater, the water spraying procedure W₁ starts to spray water onto the dishes. Simultaneously with the completion of the operation of the first heater, the water spraying procedure is completed. That is, the operation time of the first heater is substantially equal to the period of time for which the water spraying period is carried out. Here, the point of time when the water spraying procedure W₁ starts corresponds to “T₁₀”, and the point of time when the water spraying procedure W₁ is completed corresponds to “T₁₂”.

Meanwhile, in order to enable the steam spraying procedure to be carried out immediately after the water spraying procedure or carried out at substantially the same time as the completing of the water spraying procedure, the second heater is configured to operate before the operation of the first heater stops. The point of time when the second heater starts to operate is represented by “T₁₁”. The time T₁₁ is earlier than the point of time T₁₂ when the operation of the first heater stops.

In detail, in FIG. 4, “A₁₁” represents an operation time for which the second heater operates. The operation time A₁₁ corresponds to a time “T₁₃-T₁₁” Also, “B₁₂” represents a period in which the first heater does not operate. The period B₁₁ corresponds to a time “T₁₁-T₁₀.”

Here, “T₁₀” represents the point of time when the main washing cycle starts. “T₁₁” represents the point of time when the second heater starts to operate. “T₁₃” represents the point of time when the operation of the second heater stops.

Thus, both the first and second heaters are maintained in an operation state, for a time “T₁₂-T₁₁”. Upon the completion of the operation of the first heater, steam is sprayed.

That is, the period of time, for which the steam spraying procedure S₁ for spraying steam is carried out, corresponds to “T₁₃-T₁₂”. Accordingly, the period of the steam spraying procedure for spraying steam is shorter than the operation time of the second heater.

Similarly to the afore-described embodiment, the water spraying procedure and steam spraying procedure are repeated in an alternating pattern in this embodiment. When the first heater operates again after completion of the operation of the second heater, the controller may control the first heater such that the first heater starts to operate after a predetermined time interval Δα elapses from the stop point of the second heater.

Here, the time interval Δα represents the time difference between the point of time T13 when the operation of the second heater stops to the point of time T20 when the first heater starts to again operate. The above-described time difference (Δα) is provided because if the first and second heaters are simultaneously controlled, the controller may be momentarily subjected to an overload.

It will be apparent to those skilled in the art that various modifications and variations can be made. Thus, it is intended that the claims cover these modifications and variations.

The dish washing machine and control method of the same have the following advantages and effects.

First, there is an advantage in that it is possible to more effectively achieve washing of dishes by alternately spraying water and steam onto the dishes while alternately operating the first and second heaters.

Second, there is an advantage in that it is possible to supply steam to the washing compartment immediately after completion of the spraying of wash water and/or at substantially the same time that the water spraying procedure ends by operating the second heater for generating steam, before the completion of the water spraying procedure for spraying wash water. Accordingly, the dish washing machine and control method are configured to provide time-saving and energy-saving benefits by not permitting any delays to

occur between the procedures.

What is claimed is:

1. A dish washing machine comprising:
a first heater to heat wash water for washing;
a second heater to generate steam to be supplied to the dish washing machine; and
a controller to control the first and second heaters to turn-on at different predetermined times.

2. The dish washing machine according to claim 1, wherein the controller performs a control operation to continuously execute a water spraying procedure to spray the heated wash water, and a steam spraying procedure to spray the steam.

3. The dish washing machine according to claim 2, wherein the controller controls the second heater to operate before completion of the water spraying procedure such that the steam spraying procedure is executed successively after the completion of the water spraying procedure without a substantial delay.

4. The dish washing machine according to claim 1, wherein the controller controls the first and second heaters to operate alternately at predetermined intervals.

5. The dish washing machine according to claim 1, wherein the first heater is installed in a sump configured to contain the wash water, and the second heater is installed in a steam generator arranged independently of the sump.

6. The dish washing machine according to claim 1, wherein the first and second heaters operate in at least one of a main washing cycle for washing the dishes, and a rinsing cycle for rinsing the dishes.

7. The dish washing machine according to claim 1, wherein the controller controls an operation time of the first heater and an operation time of the second heater such that the operation times have an overlap period.

8. The dish washing machine according to claim 7, wherein the controller controls the operation time of the first heater and a wash water spraying time such that the times are substantially equal.

9. A dish washing machine comprising:
a first heater for heating wash water for washing;
a second heater for generating steam to be supplied to the dish washing machine; and
a washing compartment to provide an interior space for washing, wherein the steam and the wash water are supplied to the washing compartment, and wherein a temperature increment associated with the first heater is followed by a temperature increment associated with the second heater.

10. The dish washing machine according to claim 9, wherein the temperature increment of the second heater occurs at a higher temperature range than the temperature increment of the first heater.

11. The dish washing machine according to claim 9, wherein a magnitude of temperature increments associated with the second heater is reduced during a course of a main washing cycle.

12. A method for a washing cycle of a home appliance, comprising:
operating a first heater to heat washing fluid for a water spraying procedure; and
operating a second heater to generate steam for a steam spraying procedure, wherein the second heater is operated prior to a completion of the water spraying procedure such that the steam spraying procedure successively follows the water spraying procedure.

13. The method according to claim 12, further comprising:
performing a plurality of water spraying procedures and steam spraying procedures, wherein the water spraying procedures and the steam spraying procedures are alternately performed.

14. The method according to claim 12, wherein the second heater operates during a portion of the water spraying procedure, while the first heater is turned off during the portion of the water spraying procedure.

15. The method according to claim 12, wherein an interval elapses between turning off the first heater and operating a second heater.

16. The method according to claim 15, wherein the elapsed interval occurs during the water spraying procedure.

17. The method according to claim 12, wherein the second heater is not turned off at a same time that the first heater is turned on.

18. The method according to claim 12, wherein a length of a time period of the water spraying procedure is different than a length of a time period associated with the operation of the first heater.

19. The method according to claim 12, wherein a length of a time period associated with the operation of the first heater is different than a length of a time period associated with the operation of the second heater.

20. The method according to claim 12, further comprising:
controlling an operation time of the first heater and operation time of the second heater such that the operation times have an overlapping period.
